(19) United States
(12) Patent Application Publication
(10) Pub. No.: US 2005/0260436 A1
(43) Pub. Date: Nov. 24, 2005

(54) Wear resistant coating for piston rings

(76) Inventors: Peter J. Einberger, Muskegon, MI (US); Thomas J. Smith, Muskegon, MI (US); Thomas Stong, Kent City, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/028,096

(22) Filed: Jan. 3, 2005

Related U.S. Application Data
(60) Provisional application No. 60/573,968, filed on May 24, 2004.

(51) Int. Cl. B32B 15/00

(52) U.S. Cl. 428/655

(57) ABSTRACT

A wear resistant coating for protecting surfaces undergoing sliding contact is disclosed. The wear resistant coating is applied by high velocity plasma process deposition of a powdered blend of the coating constituents. The powdered blend includes a nickel-chromium alloy, chromium carbide, and molybdenum. The molybdenum powder has a particle size of less than about 45 microns. The disclosed coating should find use as a bearing surface on piston rings, cylinder liners, and other components of a power cylinder assembly of an internal combustion engine.

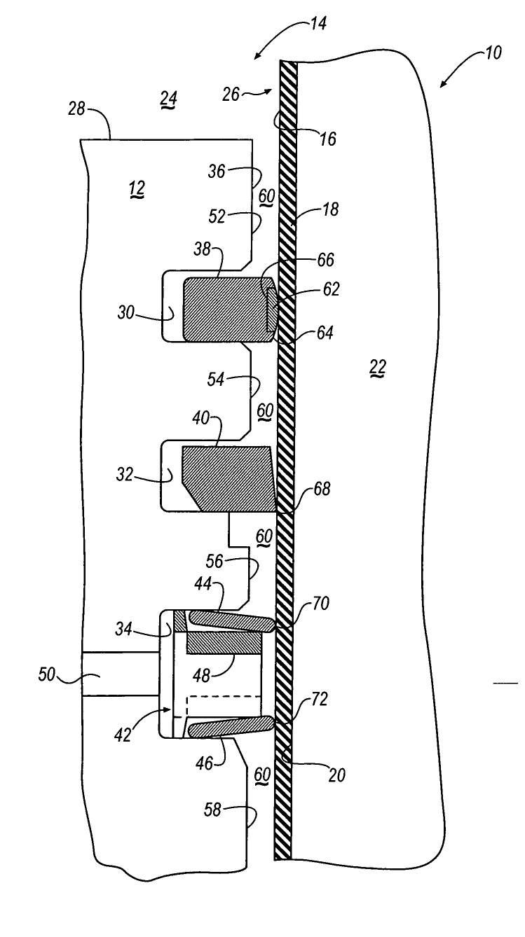

### CROSS REFERENCE TO RELATED APPLICATIONS

This application claims the benefit of Provisional Application 60/573,968, filed on May 24, 2004, the contents of which are hereby incorporated herein in their entirety.

### TECHNICAL FIELD

The present invention relates to materials and methods for protecting surfaces subject to frictional forces, heat, and corrosion, and more particularly, to wear-resistant coatings that can be applied to piston rings and cylinder liners of internal combustion engines.

### BACKGROUND OF THE INVENTION

A power cylinder assembly of an internal combustion engine generally comprises a reciprocating piston disposed within a cylindrical cavity of an engine block. One end of the cylindrical cavity is closed while another end of the cylindrical cavity is open. The closed end of the cylindrical cavity and an upper portion or crown of the piston, define a combustion chamber. The open end of the cylindrical cavity permits oscillatory movement of a connecting rod, which joins a lower portion of the piston to a crankshaft, which is partially submersed in an oil sump. The crankshaft converts linear motion of the piston (resulting from combustion of fuel in the combustion chamber) into rotational motion.

The power cylinder assembly typically includes one or more piston rings and a cylindrical sleeve or cylinder liner, which is disposed within the engine block and forms the side walls of the cylindrical cavity. The piston rings are disposed in grooves formed in the lateral walls of the piston, and extend outwardly from the piston into an annular space delineated by the piston wall and the cylinder liner. During movement of the piston within the cylindrical cavity, the piston rings bear against the cylinder liner. The piston rings have two main functions. First, they inhibit gas flow from the combustion chamber into the oil sump through the annular space between the piston and the cylinder liner. Second, they minimize oil flow from the oil sump into the combustion chamber.

To improve their durability, wear and scuff resistance, the piston rings, and in some cases the cylinder liner, are coated with relatively hard materials such as chromium hard plate and alloys containing chromium carbide. Although such coatings have met with considerable success, they have been found inadequate for newer engine technologies, including diesel engines employing exhaust gas recirculation (EGR).

For high firing pressure diesel applications, known plasma spray thermal coatings either exhibit insufficient ring wear or excessive bore wear to meet established durability requirements. Also, current hexavalent chrome plating has problems with scuffing in highly loaded engines along with environmental impact issues such as increased waste streams.

### SUMMARY OF THE INVENTION

The present invention provides coatings that offer improved wear and scuff resistance for demanding applications such as piston rings and cylinder liners of internal combustion engines. In one embodiment, a wear resistant coating is applied with a high velocity plasma process. The coating is a powder coating and the powder includes about 13 wt. % to about 43 wt. % of a nickel-chromium alloy, about 25 wt. % to about 64 wt. % chromium carbide, and about 15 wt. % to about 50 wt. % molybdenum, wherein chromium from the nickel-chromium alloy is at least 7.2 wt % of the blend.

In another embodiment, a piston ring having a wear resistant coating is provided, where the coating includes a blended powder comprising a pre-alloyed chrome carbide powder and a metallic molybdenum powder, the is coating applied by subjecting the powder to a high velocity plasma process.

In yet another embodiment, a method for forming a wear resistant coating to a piston ring is provided where the method includes combining a powder with a pre-alloyed chrome carbide and a powder of a metallic molybdenum to form a blended powder and applying the blended powder to the piston ring using a high velocity plasma process.

The invention is also directed to a chemistry and prealloyed microstructure in a chrome carbide/nickel chrome constituent plus the addition of molybdenum utilizing a unique plasma spray thermal process. The process has the advantage of lower investment and operational costs than competing technologies such as physical vapor deposition (PVD), high-velocity oxy-fuel (“HVOF”), and advanced chrome plating.

The present invention is an improvement of the invention disclosed in U.S. Pat. No. 6,562,480, the contents of which are incorporated by reference. The present invention is also an improvement on co-pending application Ser. No. 10/804,332, the contents of which are incorporated by reference herein in their entirety. The present invention is an improvement on co-pending application Ser. No. 10/255,814, the contents of which are incorporated by reference herein in their entirety.

### BRIEF DESCRIPTION OF THE DRAWINGS

The figure is a sectional side view of a portion of a power cylinder assembly illustrating a piston ring with a wear resistant coating made in accordance with an embodiment of the present invention.

### DESCRIPTION OF THE PREFERRED EMBODIMENT

Referring to the figure, a sectional side view of a portion of a power cylinder assembly 10 of an internal combustion engine is illustrated. The power cylinder assembly 10 includes a piston 12, which can move linearly within a cylindrical cavity 14 that is defined by an inner wall 16 of a cylinder liner, or a cylindrical sleeve, 18. The cylinder liner 18 is disposed within a cylindrical bore 20 formed in an engine block 22.

The power cylinder assembly 10 also includes a combustion chamber 24, which is defined by an upper portion 26 of the cylinder liner 18 and a top portion or crown 28 of the piston 12. During engine operation, fuel combustion in the combustion chamber 28 generates gas pressure that pushes against the crown 28 of the piston 12, driving the piston 12 downward.

In addition to the crown 28, the piston 12 includes a first groove 30, a second groove 32, and third groove 34 formed in a lateral wall 36 of the piston 12. Each of the grooves 30, 32, 34 are sized to accept, respectively, first 38 and second 40 piston (compression) rings, and an oil ring assembly 42. The oil ring assembly 42 includes a pair of rails 44, 46, and a sinusoidal expander 48, which pushes the rails 44, 46 outward from the lateral wall 36 of the piston 12. The expander 48 also includes a drain slot 50 (shown by hidden lines) that channels oil away from the inner wall 16 of the cylinder liner 18 to an oil sump via a conduit (not shown) within the piston 12. As can be seen in the figure, a first land 52, a second land 54, and a third land 56 separate each of the grooves 30, 32, 34 and help retain the pistons rings 38, 40 and the oil ring assembly 42 in their respective grooves 30, 32, 34. The piston 12 also includes a lower skirt 58, which reduces lateral movement of the piston 12 during the combustion cycle.

As shown in the figure, the first 38 and second 40 piston rings, and the rails 44, 46 of the oil ring assembly 42, contact the inner wall 16 of the cylinder liner 18. The rings 38, 40 and rails 44, 46 act as sliding seals that prevent fluid flow through an annular region 60 formed by the lateral wall 36 of the piston 12 and the inner wall 16 of the cylinder liner 18. Thus, the first piston ring 38, and to some extent the second piston ring 40 and the oil ring assembly 42 rails 44, 46, reduce gas flow from the combustion chamber 24 to the oil sump region of the engine. Similarly, the rails 44, 46 of the oil ring assembly 42 and the second 40 piston ring (and to less extent the first 38 piston ring), help prevent oil in the sump from leaking into the combustion chamber 24.

In the embodiment illustrated, a coating 62 is disposed on a radial periphery 64 of the first piston ring 38 to improve durability, wear resistance and scuff resistance of the first piston ring 38 and the cylinder liner 18. As can be seen, the radial periphery 64 of the first piston ring 38 includes a radial groove 66, which improves the adhesion of the coating 62 to the first piston ring 38. The coating 62 may also be applied to other surfaces of the power cylinder assembly 10 that are subject to frictional forces (bearing surfaces), heat, or corrosion. Such surfaces include, but are not limited to, the inner wall 16 of the cylinder liner 18, and radial peripheries 68, 70, 72 of the second piston ring 40 and the rains 44, 46 of the oil ring assembly 42.

The coating 62 comprises an alloy of one or more base metals, a hard ceramic material, and molybdenum. The base metal serves as a binder for the hard ceramic material. Suitable base metals include nickel, chromium, and, preferably, mixtures of nickel and chromium. A useful base metal is a nickel-chromium alloy containing from about 40 wt. % to about 60 wt. % nickel. The base metal generally comprises about 13 wt. % to about 43 wt. % of the coating 62, and more particularly, about 18 wt. % to about 35 wt. % of the coating 62. An especially useful coating 62 includes about 28 wt. % of a nickel-chromium alloy containing about 50 wt. % nickel.

The hard ceramic material, which imparts wear resistance, ordinarily should remain substantially solid throughout application of the coating 62. Examples of hard ceramic materials include chromium carbide, vanadium carbide, and tungsten carbide. Of these, chromium carbide is especially useful. The hard ceramic materials are available as finely divided powders ranging in size from about 15 microns to about 45 microns. Useful forms of chromium carbide include Cr₃C₂, Cr₇C₃, and Cr₂₃C₆, among others, and a mixture of Cr₇C₃, and Cr₂₃C₆ is particularly advantageous. The hard ceramic material generally comprises about 25 wt. % to about 64 wt. % of the coating 62, and more particularly, about 35 wt. % to about 53 wt. % of the coating 62. When the chromium carbide level is less than about 25 wt. %, the abrasion or wear resistance of the coating 62 is inadequate for power cylinder applications, and when the chromium carbide level is greater than about 64 wt., the coating 62 is too brittle. A particularly useful coating 62 comprises about 42 wt. % chromium carbide, which includes about 50 wt. % Cr₇C₃ and about 50 wt. % Cr₂₃C₆.

While the powder may include various components, in a preferred embodiment it consists of two components. The first component is a pre-alloyed chrome carbide (predominantly Cr₇C₃ and Cr₇C₃ and Cr₂₃C₆) nickel chrome (approximately 60/40 ratio and more preferably a 60/40 ratio) such as that available from Praxair Surface Technologies Inc. The second component is essentially pure molybdenum. The two powder components are mechanically blended to approximately a 70/30 ratio (CRC-NiCr/Mo) ratio. The actual ratio ranges that can be used are discussed in greater detail in the '480 patent.

The method of applying the coating 62 includes employing a spraying technique. The spraying technique utilizes a high velocity plasma process, which is a low oxidation thermal spraying technique. The technique results in a higher deposit efficiency than HVOF and has improved wear performance over traditional thermal spray plasma techniques.

In thermal spraying processes such as a high velocity plasma process that utilize a carrier gas, flight time and oxidation can be decreased by increasing flow rate of the carrier gas. In a plasma process, increasing the flow rate of the plasma can be accomplished by using a greater volume of fuel gas in a given time period, increasing the voltage and/or the amperage used to create the electric arc, and/or using different fuel gas mixture to generate the plasma flame. For example, typically fuel gas is used at a volume of around 100 standard cubic feet/hour (cfh). Increasing the volume of fuel gas to more than 200 cfh will decrease oxidation. Increasing the voltage and amperage from the typical 30 volts and 600 amps to 50-70 volts and 800-1000 amps has the effect of decreasing oxidation. Preferably, a voltage of about 60 volts is used in combination with amperage of about 900 amps. Indeed, a fuel gas of argon and helium allows less oxidation than a fuel gas of argon and hydrogen. In a preferred method, an argon/helium fuel gas is used at a volume of 200 cfh of argon and a volume of 30 cfh helium. Obviously, using more than one of these techniques may have a synergistic effect on the reduction of oxidation of the coating material.

Finally, it has been found that particle size is unexpectedly very important to the proper creation of the wear coating. In the prior art, the CrC/NiCr size=15 to 45 microns while the Molybdenum size=45 to 74 microns. Molybdenum of 45 to 74 microns was found to have inadequate fusion.

For the present invention, the CrC/NiCr size=15 to 45 microns while the Molybdenum size=15 to 45 microns. The smaller particle size of Molybdenum provides appropriate fusion when applied in accordance with the teachings of the present invention. In fact, while having a particle size of less than 45 microns is important, having the smallest possible size results in a lack of improvement over the overall fusion. In particular, Molybdenum powder of 15 to 25 microns was found to perform no better than powder of slightly greater size than 25 microns.

Although the base metal and the hard ceramic component of the coating 62 can be dry-blended, it is advantageous to pre-alloy the components prior to application. Suitable alloying techniques include liquid and gas atomization, which generate particles having substantially uniform concentrations of the base metal and the hard ceramic component. For example, a pre-alloyed mixture of chromium carbide and nickel-chrome, which is produced by atomization, is available under the trade designation CRC-291 from Praxair Inc. The pre-alloyed mixture comprises about 60 wt. % chromium carbide, primarily as Cr₇C₃ and Cr₂₃C₆, and about 40 wt. % of a nickel-chrome alloy. The chromium carbide portion of the mixture contains about equal amounts (by weight) of Cr₇C₃ and Cr₂₃C₆, and the nickel-chrome alloy contains about equal amounts (by weight) of nickel and chromium. The pre-alloyed mixture has a maximum particle size less than about 53 microns. For a description of liquid atomization, see U.S. Pat. No. 5,863,618, “Method for Producing a Chromium Carbide-Nickel Chromium Atomized Powder,” which is herein incorporated by reference.

In addition to the base metal and the hard ceramic component, the coating 62 also includes molybdenum, which imparts scuff resistance. Here, scuffing refers to binding or grabbing that may occur when two surfaces, such as the piston rings 38, 40 and the cylinder liner 18, are in sliding contact. In extreme cases of scuffing, the intense heat generated by friction may cause the two surfaces to weld together. The molybdenum component of the coating 62 may include a few weight percent impurities, such as metal oxides, and generally ranges in particle size from about 105 microns to less than about 45 microns. For power cylinder applications, molybdenum should comprise between about 15 wt. % and 50 wt. % of the coating 62-molybdenum levels less than about 15 wt. % result in coatings 62 having inadequate scuff resistance, and molybdenum levels greater than about 50 wt. % result in coatings 62 having inadequate wear resistance. A particularly useful coating 62 comprises about 30 wt. % molybdenum.

The application of coating 62 involves the spraying of a metallic powder using a plasma spray thermal process onto the outer periphery of a piston ring body. The ensuing coating is designed to improve the wear and scuff characteristics of the piston ring. Preferably, the coating is deposited in at least a peripheral groove in the ring.

Prior to application, the powders that comprise the coating 62—base metal, hard ceramic component, molybdenum—are mixed in a dry state using a v-cone blender, a ball mill, and the like. Once blended, the coating 62 constituents are applied to the first piston ring 38, cylinder liner 18, or other bearing surfaces of the power cylinder 10. To efficiently coat a piston ring's radial periphery, a group of piston rings are stacked on an arbor having a controllable rotation rate. A nozzle, which propels the coating 62 constituents against the outer periphery of each of the rings, is mounted on a translation stage, which can control the position of the nozzle relative to the stack of piston rings. Prior to coating, the translation stage adjusts the standoff distance from the thermal spray nozzle tip to the stack of piston rings. To coat the rings, the arbor rotates the piston rings at a desired angular velocity while the translation stage moves the nozzle between the ends of the stack along the arbor's axis at a desired speed. For a given powder feed rate, one can adjust the coating thickness by adjusting the angular velocity of the arbor and the translation speed of the nozzle. Preferably, one can adjust the coating thickness by changing the number of nozzle translations over the arbor. Following application of the coating 62, the stack of piston rings are separated and finished by grinding.

While the invention has been described with respect to specific examples including preferred modes of carrying out the invention, those skilled in the art will appreciate that there are numerous variations and permutations of the above described systems and techniques that fall within the spirit and scope of the invention as set forth in the appended claims.

1. A wear resistant coating for protecting a surface of a piston ring, the wear resistant coating applied by a high velocity plasma process, the powder comprising a blend of:
about 13 wt. % to about 43 wt. % of a nickel-chromium alloy;
about 25 wt. % to about 64 wt. % chromium carbide; and
about 15 wt. % to about 50 wt. % molybdenum, wherein chromium from the nickel-chromium alloy is at least 7.2 wt % of the blend.

2. The wear resistant coating of claim 1, wherein there is about 18 wt % to about 35 wt. % of a nickel-chromium alloy.

3. The wear resistant coating of claim 1, wherein there is about 35 wt % to about 53 wt. % of chromium carbide.

4. The wear resistant coating of claim 1, wherein there is about 18 wt % to about 35 wt. % of a nickel-chromium alloy and about 35 wt % to about 53 wt. % of chromium carbide.

5. The wear resistant coating of claim 1, wherein said chromium carbide component comprises Cr₇C₃ and Cr₂₃C₆.

6. The wear resistant coating of claim 1, wherein said molybdenum powder has a particle size of about 15 microns to about 45 microns.

7. The wear resistant coating of claim 1, wherein said molybdenum powder has a particle size of about 25 microns to about 45 microns.

8. A piston ring having a wear resistant coating, the coating comprising:
a blended powder comprising a pre-alloyed chrome carbide powder and a metallic molybdenum powder;
said coating applied by subjecting said powder to a high velocity plasma process.

9. The piston ring of claim 8, wherein said coating further comprises about 18 wt % to about 35 wt. % of a nickel-chromium alloy.

10. The piston ring of claim 8, wherein said coating further comprises about 35 wt % to about 53 wt. % of chromium carbide.

11. The piston ring of claim 8, wherein said chromium carbide component comprises Cr₇C₃ and Cr₂₃C₆.

12. The piston ring of claim 8, wherein said molybdenum powder has a particle size of about 15 microns to about 45 microns.

13. The piston ring of claim 8, wherein said molybdenum powder has a particle size of about 25 microns to about 45 microns.

14. A method for forming a wear resistant coating to a piston ring comprising:
combining a powder with a pre-alloyed chrome carbide and a powder of a metallic molybdenum to form a blended powder; and
applying said blended powder to said piston ring using a high velocity plasma process.

15. The method of claim 14, wherein said blended powder comprises about 18 wt % to about 35 wt. % of a nickel-chromium alloy.

16. The method of claim 14, wherein said blended powder comprises about 35 wt % to about 53 wt. % of chromium carbide.

17. The method of claim 14, wherein said chromium carbide component comprises Cr₇C₃ and Cr₂₃C₆.

18. The method of claim 14, wherein said molybdenum powder has a particle size of about 15 microns to about 45 microns.

19. The method of claim 14, wherein said molybdenum powder has a particle size of about 25 microns to about 45 microns.
